(19) United States
(12) Patent Application Publication
(10) Pub. No.: US 2024/0239035 A1
(43) Pub. Date: Jul. 18, 2024

(54) METHOD FOR PRODUCING A CARDBOARD-PLASTIC COMPOSITE SHELL, AND PRODUCTION DEVICE

(71) Applicant: Syntegon Technology GmbH, Waiblingen (DE)

(72) Inventor: Gebhard Selinger, Lorch (DE)

(21) Appl. No.: 18/558,924

(22) PCT Filed: May 4, 2022
(86) PCT No.: PCT/EP2022/062027

§ 371 Date: Nov. 3, 2023

(30) Foreign Application Priority Data
May 4, 2021 (DE) 10 2021 111 563.9

(51) Int. Cl. B29C 53/04; B29C 51/08; B29C 51/16; B29C 51/42; B29K 23/00; B29K 711/12; B29L 31/00; B31B 50/59; B31B 120/40; B65D 5/20; B65D 5/60

(52) U.S. Cl. CPC B29C 53/04; B29C 51/082; B29C 51/165; B29C 51/428; B31B 50/592; B65D 5/2047; B65D 5/60; B29C 2791/001; B29K 2023/0633; B29K 2023/086; B29K 2023/12; B29K 2711/12; B29L 2031/7162; B31B 2120/407

(57) ABSTRACT

A method for producing a cardboard-plastic composite shell (10), in particular an MAP cardboard-plastic composite shell for food products, includes at least the method steps (66, 68, 82, 88) providing a plastic foil (12), pre-forming the plastic foil (12) to form a shell shape (14), providing a cardboard blank (16), and connecting the cardboard blank (16) to the already pre-formed plastic foil (12) in order to form the cardboard-plastic composite shell (10). The cardboard blank (16) provided is not folded or incompletely folded directly before the connection to the pre-formed plastic foil (12). When the cardboard blank (16) is connected to the pre-formed plastic foil (16), the cardboard blank (16) is folded onto the plastic foil (12) by a stamp mechanism (24).

### CROSS REFERENCE TO RELATED APPLICATIONS

This application is based on and incorporates herein by reference the German patent application DE 10 2021 111 563.9, filed on May 4, 2021, as well as the international patent application PCT/EP2022/062027, filed on May 4, 2022.

### BACKGROUND

The invention concerns a method for producing a cardboard-plastic composite shell and a production device.

It has already been proposed in the documents U.S. Pat. No. 10,647,466 B2 und US 2020/0247571 A1 that a plastic foil is laminated into a pre-folded cardboard box. In order to enable an insertion of the plastic foil into the cardboard box and a planar lining of the cardboard box with the plastic foil in a manner that is, for example, as bubble-free as possible, the cardboard box has in edge regions vent holes through which the air imprisoned between the plastic foil and the cardboard box in the connecting process escapes and/or is even actively suctioned off. This requires specifically shaped forming tools which have airing openings and special cardboard blank geometries.

Furthermore, from DE 196 20 396 A1, DE 23 31 005 A1, DE 195 09 100 A1, U.S. Pat. No. 3,917,155 A, CA 3 138 383 A1 and WO 00/75025 A1 methods for producing a cardboard-plastic composite shell are already known, wherein the known methods comprise at least the following method steps:
providing a plastic foil,
pre-forming the plastic foil to form a shell shape,
providing a cardboard blank,
connecting the cardboard blank to the already pre-formed plastic foil in order to form the cardboard-plastic composite shell constituting a cup-shaped packaging for receiving food products.

Furthermore, production devices for a production of cardboard-plastic composite shells according to the known methods and the cardboard-plastic composite shells produced with the known methods are already known.

### SUMMARY

The invention is based on a method for producing a cardboard-plastic composite shell, in particular an MAP (Modified-Atmosphere-Packaging) cardboard-plastic composite shell for food products, comprising at least the method steps: a) providing a plastic foil, b) pre-forming the plastic foil to form a shell shape, c) providing a cardboard blank and d) connecting the cardboard blank to the already pre-formed plastic foil in order to form the cardboard-plastic composite shell.

It is proposed that the cardboard blank provided is not folded or incompletely folded directly before the connection to the pre-formed plastic foil, wherein when the cardboard blank is connected to the pre-formed plastic foil, the cardboard blank is folded onto the plastic foil by means of a stamp mechanism. This advantageously allows achieving a simple, cost-efficient and/or quick production of cardboard-plastic composite shells, in particular as it is possible to dispense with a venting of the cardboard box formed from the cardboard blank and/or with a suctioning of air out of the cardboard box during the production. However, it is alternatively also conceivable that the cardboard box is already fully folded before the connection to the plastic foil and is applied onto the pre-formed plastic foil in a fully-folded state. In particular, in the case of an incompletely folded cardboard blank there is a substantial gap between contacting edges of neighboring sidewalls of the cardboard-plastic composite shell. Advantageously, a consumption of plastic is reduced in comparison to full-plastic shells.

In particular, the cardboard-plastic composite shell consists at least substantially of two components: the cardboard blank and the plastic foil. In particular, the two components of the cardboard-plastic composite shell are connected to each other face-to-face, and in particular free of additionally applied gluing materials, for example by press-lamination. The cardboard blank is preferably made of a recycling material (recovered paper), of new cellulose, or of groundwood pulp. In the context of the invention described here, the term “cardboard” is to mean any conceivable kind of cellulose and/or paper products (for example also paperboard or the like). Preferably the cardboard of the cardboard blank has a grammage between 300 g/m² and 500 g/m², preferentially 360 g/m². The cardboard blank is preferably free of gluing tabs or the like. The cardboard blank is in particular configured to form a shell-shaped box and/or to be folded to a shell-shaped box. The shell-shaped box made from the cardboard blank preferably constitutes a physical barrier against a damaging of the contents of the cardboard-plastic composite shell and/or against a damaging of a (gas and/or humidity) barrier layer implemented by the plastic foil. The shell-shaped box made from the cardboard blank realizes an outer side of the cardboard-plastic composite shell. The plastic foil in particular realizes an inner side of the cardboard-plastic composite shell. By an “MAP cardboard-plastic composite shell” is in particular a cardboard-plastic composite shell to be understood that is designed to be used in a packaging process in which a selective change in a gas composition is carried out during a closing process in the interior of a gas-tight packaging. In particular, the cardboard-plastic composite shell can be closed in a completely gastight/airtight manner by applying a gastight/airtight lid.

In particular, the plastic foil is produced in step a) in a planar form. Preferably, a “plastic foil” is to mean a thin sheet of a synthetic material, which is in particular first produced in endless webs and rolled, and is cut into suitable pieces later on. Preferably the plastic foil has a thickness between 40 μm and 100 μm, preferentially 60 μm. In particular, the plastic foil is capable of being sealed, such that the cardboard-plastic composite shell can be closed and/or sealed after filling (for example by means of a cover foil). Preferably the plastic foil is expandable, preferentially expandable by at least 50% without destruction/rupture. Preferably the plastic foil is realized of a synthetic material having a high barrier effect with regard to water vapor, oxygen, nitrogen and/or further gaseous substances. The plastic foil is made, for example, of a polyethylene (PE/LDPE), in particular of a PE having an ethylene-vinylalcohol copolymer (EVOH) separation layer, of a polypropylene (PP). It is also conceivable that the plastic foil is made of a biodegradable synthetic material. In particular, the plastic foil is realized in one-layer fashion. Preferably the plastic foil is not a composite foil of several different synthetic materials, in particular synthetic materials of different classes. However, it is conceivable that the plastic foil is a composite foil whose components belong to a common class of synthetic materials, which are in particular conjointly recyclable, i. e. for example a composite foil of layers of different PE plastic types. In particular, in the providing a planar plastic foil web is wound off a reel and is clamped into a frame. In particular, the region of the plastic foil web that is clamped in the frame is formed in the pre-forming. In particular, the pre-forming is carried out before bringing the plastic foil together with the cardboard blank. In particular, first of all the plastic foil is pre-formed and then the plastic foil is brought into a connection with the (non-folded or only partially folded) cardboard blank. By a “shell shape” is in particular any shape to be understood which has a bottom and has sidewalls starting from the bottom and making a 360° circumference in order to form a receiving space. In particular, in the context of the invention that is described here, a dish shape, a plate shape, a cup shape and further container shapes with access openings shall be understood as shell shapes according to the invention. Preferably the sidewalls of the shell shape have a height of at least 5%, preferably at least 10% or preferentially at least 20% of a width or a depth of the bottom of the shell shape. In particular, a length of a shortest side edge of a smallest geometrical rectangular cuboid just still completely enclosing the finished cardboard-plastic composite shell amounts to at least 5%, preferably at least 10% or preferentially at least 20% of a length of a longest side edge of the smallest geometrical rectangular cuboid just still completely enclosing the finished cardboard-plastic composite shell.

In particular, the cardboard blank is provided in a planar form. In particular, the cardboard blank is realized so as to form after a folding a shell shape, which preferably at least substantially corresponds to the shell shape of the pre-formed plastic foil, at least on an inner side. In particular, at least a section of the cardboard blank is connected to the plastic foil before the cardboard blank is fully folded/before the cardboard blank is folded into its final shape. “Configured” is in particular to mean specifically programmed, designed and/or equipped. By an object being configured for a certain function is in particular to be understood that the object fulfills and/or executes said certain function in at least one application state and/or operation state.

Furthermore, it is proposed that the cardboard blank is connected to the plastic foil in such a way that the plastic foil and the cardboard blank are separable manually, in particular such that they can be recycled. This advantageously allows attaining a high level of environmental compatibility. In particular, the plastic foil can be pulled off the cardboard (manually). Preferentially, the plastic foil can be separated from/pulled off the cardboard of the cardboard blank in such a way that, when plastic foil and cardboard have been separated, the cardboard is at least substantially free of foil residue and the plastic foil is at least substantially free of cardboard residue. In this way a high level of recyclability of the cardboard-plastic composite shell is advantageously achievable. Preferably, in order to enable manual separability, the cardboard blank and the plastic foil are connected to each other free of additionally applied gluing materials. In particular, the plastic foil of the finished cardboard-plastic composite shell comprises at least one tab or an excess length that can be gripped for the purpose of pulling the plastic foil off the cardboard of the cardboard blank.

It is also proposed that the plastic foil is connected to the cardboard blank by lamination. This advantageously allows achieving favorable separability of plastic foil and cardboard, thus ensuring a high degree of recyclability and/or environmental compatibility. Moreover, a simple production method is achievable, which is preferably environmentally compatible because it is free of gluing materials. In particular, the plastic foil is connected to the cardboard of the cardboard blank by hot lamination and/or by press-lamination, preferentially by a combination of hot lamination and press-lamination. A “lamination” is in particular to mean a substance-to-substance bonding, preferably thermal and/or pressure-generated, joining method, which does not require a utilization of auxiliary materials, like gluing materials or the like. Alternatively to the hot or press-lamination and/or alternatively to the combination of hot and press-lamination, it is also conceivable that the plastic foil is connected to the cardboard of the cardboard blank by cold lamination. Preferably, in particular in the case of cold lamination, in at least one method step a cold-sealing agent is applied onto the plastic foil and/or onto the cardboard of the cardboard blank. Preferentially, in at least one method step, in particular in the case of cold lamination, after applying the cold-sealing agent the plastic foil and the cardboard of the cardboard blank are connected by pressing, in particular by pressing them onto each other. When using a cold-sealing agent, it is advantageously possible to dispense with a special hot-sealing layer on the plastic foil. Advantageously, as far as possible independency is achievable from temperature windows during which the plastic foil is formed and/or during which a hot-sealing process takes place. Advantageously, as far as possible independency is achievable from the plastic foil that is to be connected as well as from a surface of the cardboard of the cardboard blank, such that a great variety of cardboard types are utilizable for the method, in particular as for example a plastic foil intended for hot lamination will behave differently with rough gray-board than with a cardboard having a painted/varnished/printed surface.

Moreover, it is proposed that a dimensional stability of the cardboard-plastic composite shell is created by the plastic foil that is connected with the cardboard of the cardboard blank by lamination. This advantageously allows achieving a simple production method, which is preferably environmentally compatible as it does not require any gluing material. Furthermore, a total material consumption can be kept at a low lever, thus in particular reducing costs. In particular, the respective sidewalls of the cardboard blank are held in the intended folding position by the plastic foil.

It is also proposed that in the pre-forming the plastic foil is brought, in particular drawn, into a shape which at least substantially corresponds to an inner shape of the cardboard-plastic composite shell that is to be attained. In this way a simple, cost-efficient and/or quick production of cardboard-plastic composite shells is advantageously achievable. In particular, during the pre-forming a forming tool that is realized as a stamping tool is pressed into the frame holding the plastic foil.

If the plastic foil is heated during the pre-forming or directly before the pre-forming, the pre-forming process is advantageously optimizable. In this way in particular a plasticity of the plastic foil is increased. In particular, the plastic foil is heated in the pre-forming process to temperatures between 80° ° C. and 170° C.

In addition, it is proposed that when the cardboard blank is connected to the pre-formed plastic foil, a subregion of the cardboard blank, which is configured to form a bottom of the cardboard-plastic composite shell, is connected to the plastic foil—in particular temporally—before a subregion of the cardboard blank that is configured to form a sidewall of the cardboard-plastic composite shell. In this way a simple, cost-efficient and/or quick production of cardboard-plastic composite shells is advantageously achievable, in particular as a venting of the cardboard box formed from the cardboard blank and/or a suctioning of air out of the cardboard box can be dispensed with during production. Advantageously, during the folding process the air escapes between plastic foil and cardboard of the cardboard blank without auxiliary means or venting holes.

If according to the invention, when the cardboard blank is connected to the pre-formed plastic foil, the cardboard blank is folded onto the plastic foil by means of a folding mechanism and/or by means of the stamp mechanism, simple, cost-efficient and/or quick production of cardboard-plastic composite shells is advantageously achievable in which, in particular during the folding process, the air escapes between the plastic foil and the cardboard of the cardboard blank without additional auxiliary means or venting holes. In particular, when the cardboard blank is folded onto the pre-formed plastic foil, the subregions of the cardboard blank which are configured to form the sidewalls of the cardboard-plastic composite shell are folded out of the plane of the subregion of the cardboard blank that is configured to form the bottom of the cardboard-plastic composite shell.

If moreover, in particular when the cardboard blank is connected to the pre-formed plastic foil, the cardboard blank is folded in such a way that the folded cardboard blank remains free of intersections and/or overlaps with itself and with further cardboard blanks, it is advantageously possible to attain particularly low consumption of resources. In addition, advantageously a planar sealing surface, on which a cover foil or the like may be tightly applied, can be created in this way.

In this context it is proposed that when the cardboard blank is folded, a sealing edge is created which is planar and/or free of layer jumps, and which in particular runs around a shell opening of the finished cardboard-plastic composite shell. As a result, the cardboard-plastic composite shell is advantageously tightly sealable. In particular, the shell opening is arranged opposite the bottom of the cardboard-plastic composite shell. In particular, the sealing edge of the cardboard blank that has been folded to form the box, preferably a sealing plane of the sealing edge of the cardboard blank that has been folded to form the box, runs at least substantially parallel to the bottom of the cardboard blank that has been folded to form the box, in particular of the cardboard-plastic composite shell. In particular, following a filling the cardboard-plastic composite shell is sealed by applying the cover foil and hot-sealing the cover foil with the plastic foil in the region of the sealing edge. The cover foil may herein be realized of a synthetic material that is identical to the plastic foil or different from the plastic foil.

Beyond this it is proposed that at least the connection of the cardboard blank to the plastic foil and/or at least the production of a box from the cardboard blank, preferably all method steps of the method for producing the cardboard-plastic composite shell, are realized completely free of an application of additional gluing materials. This advantageously allows achieving a simple, cost-efficient and quick production of cardboard-plastic composite shells which have in particular have especially favorable recycling properties because plastic foil and cardboard are easily separable after usage. In this context, a “gluing material” is in particular to mean a processing material which is different from the plastic foil and the cardboard and/or is realized separately from the plastic foil and the cardboard, and which is used in a gluing joining procedure for connecting different materials. For example, in this context a utilization of adhesive or adherent plastic foils is not considered as an application of a gluing material. For example, in this context a partial melting of plastic foils during lamination is not considered as an application of a gluing material.

Furthermore, a production device for a production of cardboard-plastic composite shells at least from respectively one plastic foil and respectively one cardboard blank by a pre-forming of the plastic foil and a following connecting of the plastic foil to the, in particular non-folded and/or incompletely folded, cardboard blank, is proposed, said production device comprising a foil pre-forming unit and a pressing device with a stamp mechanism. This advantageously allows achieving simple, cost-efficient and/or quick production of cardboard-plastic composite shells. As a result, a venting of a cardboard box and/or a suctioning of air out of the cardboard box may be dispensed with during production. The foil pre-forming unit is in particular configured to create first of all a pre-forming of the originally planar plastic foil before a connecting to the cardboard blank.

It is proposed, according to the invention, that the foil pre-forming unit comprises at least one stamping tool having an outer contour that corresponds at least substantially to an inner contour of the finished cardboard-plastic composite shell which is to be achieved, wherein the stamp mechanism comprises a further stamping tool that is realized complementarily to the stamping tool and is configured for folding and laminating in one common work step. This allows achieving an effective, cost-efficient and/or simple plastic pre-forming of the plastic foil. In particular, the foil pre-forming unit comprises the frame which spans the plastic foil in a planar fashion, and into which the stamping tool is pushed/pressed when carrying out the pre-forming. It is in particular conceivable that the stamping tool comprises venting channels and/or vacuumizing channels, which are preferably configured to ensure the plastic foil closely adjoining the stamping tool, at least in a connecting process following the pre-forming process, in which the plastic foil is laminated onto the cardboard of the cardboard blank.

It is also proposed that the foil pre-forming unit comprises at least one heating device for a heating of the plastic foil before and/or during a pre-forming of the plastic foil. In this way an effective, cost-efficient and/or simple production method is achievable, in particular as a plastic pre-formability of the plastic foil can be improved. Advantageously, an expandability of the plastic foil can be increased by heating the plastic foil before and/or during the pre-forming.

If the heating device is realized at least partially integrally with the stamping tool of the foil pre-forming unit, it is advantageously possible to ensure an effective heat transfer during the pre-forming process. Alternatively or additionally, the heating device may comprise one or several further heating elements and/or heating apparatuses which are realized separately from the stamping tool. In particular, these heating elements and/or heating apparatuses may be configured to apply a hot-air stream and/or heat radiation onto the plastic foil, in particular aiming at a heating of the plastic foil before and/or during the pre-forming process.

Furthermore, a cardboard-plastic composite shell is proposed, which is produced by the method according to the invention and/or by means of the production device according to the invention. This advantageously allows obtaining a cardboard-plastic composite shell which is producible in an especially cost-efficient and/or simple and/or quick fashion.

Beyond this, a cardboard-plastic composite shell is proposed, with a plastic foil and with a cardboard blank that is folded to form a box, wherein at least an inner side of the box that forms a storage region is completely lined with the plastic foil in such a way that the plastic foil is connected, in particular free of an additionally applied gluing material, face-to-face with the cardboard blank that is folded to form a box, wherein the box folded from the cardboard blank (differently than the known cardboard-plastic composite shells cited in the beginning) is at least substantially free of gaps at least in corner regions of the box. This advantageously allows providing a cardboard-plastic composite shell that is producible in an especially cost-efficient and/or simple and/or quick fashion. Advantageously, the cardboard-plastic composite shell is free of cardboard gaps that form weak points, for example in corner regions of the box. Advantageously this enables better protection of products, e. g. perishable food products, arranged in the storage space of the box. Preferably the cardboard-plastic composite shell is completely free of gaps, except for the shell opening. By an object being free of gaps is in particular to be understood that, except for gap tolerances between neighboring sidewalls and/or except for fold rills, fold groovings, fold slots and/or fold perforations, the object is free of gaps. In particular, the box has a bottom and sidewalls. Preferably the box is realized in a box shape (rectangular). However, alternatively other polygonal and/or partly rounded shapes are also conceivable. In particular, the box is open on one side, in particular due to the shell opening. In particular, the lining realized by the plastic foil is free of gaps and at least liquid-tight, preferably gas-tight. A “corner region” is in particular to mean a region of the box in which two side edges of folded sidewalls and the bottom of the box meet. In particular, the cardboard blank is free of airing elements intended, during a production of the cardboard-plastic composite shell, for air escaping and/or being suctioned from an interspace between plastic foil and cardboard blank. However, it is in particular conceivable that the cardboard blank has other gaps or recesses, which are in particular located away from the corner regions, and whose main purpose lies in forming a viewing window that enables an insight into the interior of the cardboard-plastic composite shell.

It is moreover proposed that in order to achieve advantageously low resource consumption, the cardboard blank that has been folded to form a box is free of intersections and/or overlaps with itself or with parts of further cardboard blanks, and/or that for an advantageous optimization of a recyclability of the cardboard-plastic composite shell, the plastic foil and the cardboard of the cardboard blank are connected to each other in such a way that simple manual separation of plastic foil and cardboard is enabled for a transfer of the plastic foil and the cardboard to different recycling streams.

It is further proposed that, in order to advantageously enable tight sealability, the cardboard blank folded to form a box forms a sealing edge which is planar and/or free of layer jumps and which runs around an opening of the box, in particular the shell opening. In this case it is moreover proposed that the sealing edge is at least largely, preferably completely, covered by the plastic foil. In this way especially favorable tightness can be ensured and/or a simple (purely thermal) sealing may be enabled. In particular, the lining of the box extends beyond the inner side of the box and beyond the sealing edge.

Furthermore, it is proposed that the cardboard blank that has been folded to form a box is realized, on an outer side situated opposite the inner side, in particular opposite the storage region, at least largely, preferably completely, free of being covered by a plastic foil or the like. In this way resource consumption, in particular a plastic fraction, and thus production costs can be kept low.

The method according to the invention, the production device according to the invention and the cardboard-plastic composite shell according to the invention shall here not be limited to the application and implementation described above. In particular, in order to fulfill a functionality that is described here, the method according to the invention, the production device according to the invention and the cardboard-plastic composite shell according to the invention may comprise a number of individual method steps, elements, components and units that differs from a number given here.

### BRIEF DESCRIPTION OF THE DRAWINGS

Further advantages will become apparent from the following description of the drawings. In the drawings exemplary embodiments of the invention are illustrated. The drawings, the description and the claims contain a plurality of features in combination. Someone skilled in the art will purposefully also consider the features separately and will find further expedient combinations.

It is shown in:

FIG. 1 a schematic perspective view of a cardboard-plastic composite shell formed from a plastic foil and a cardboard blank,

FIG. 2 a schematic plan view onto the cardboard blank in a non-folded state,

FIG. 3 a schematic illustration of a production device for a production of the cardboard-plastic composite shell during a work step,

FIG. 4 a schematic illustration of the production device during a first further work step,

FIG. 5 a schematic illustration of the production device during a second further work step,

FIG. 6 a schematic illustration of the production device during a third further work step,

FIG. 7a a schematic illustration of the production device during a first partial work step of a fourth further work step,

FIG. 7b a schematic illustration of the production device during a second partial work step of the fourth further work step,

FIG. 8 a schematic illustration of the production device during an alternative fourth further work step, and

FIG. 9 a schematic flow chart of a method for producing the cardboard-plastic composite shell.

### DETAILED DESCRIPTION

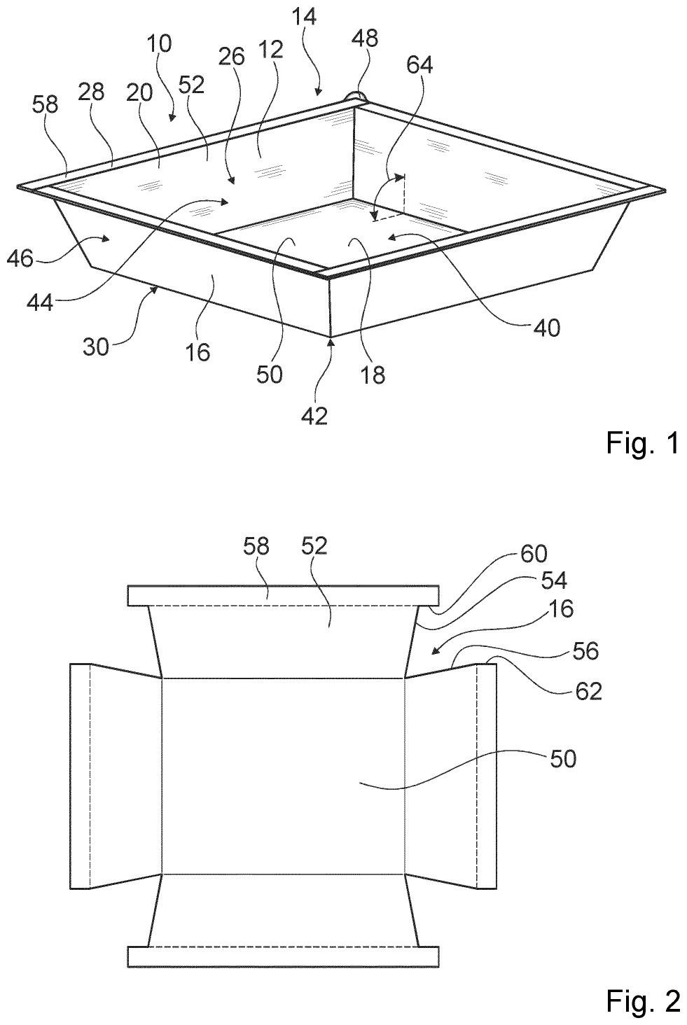

FIG. 1 shows a schematic perspective illustration of a cardboard-plastic composite shell 10. The cardboard-plastic composite shell 10 is embodied as an MAP cardboard-plastic composite shell for food products. The cardboard-plastic composite shell 10 comprises a plastic foil 12. The cardboard-plastic composite shell 10 comprises a cardboard blank 16 (see also FIG. 2). Preferably the cardboard-plastic composite shell 10 consists just of the cardboard blank 16 and the plastic foil 12, and in a closed state possibly of a cover foil (not shown). The cardboard blank 16 is folded to form a box 30. The box 30/the cardboard-plastic composite shell 10 forms a storage region 40 on an inner side 44. The box 30/the cardboard-plastic composite shell 10 is configured, for example, for receiving food products, like meat, cheese etc. Of course the storage region 40 may as well be configured for receiving other objects. Preferably the materials at least of the plastic foil 12 and/or of the cover foil, if applicable also of the cardboard blank 16, are adapted to the object that is to be received and to the respective storage requirements of the object. The plastic foil 12 provides the barrier properties required depending on the stored object and may hence be equipped with different adapted chemical-physical properties. The plastic foil 12 is expandable. The plastic foil 12 is sealable, such that the finished cardboard-plastic composite shell 10 can be closed with the cover foil. The inner side 44 of the box 30/the cardboard-plastic composite shell 10 forms the storage region 40. The storage region 40 is configured for receiving the object. The cardboard-plastic composite shell 10 has a shell opening 26. Objects can be brought into the cardboard-plastic composite shell 10 through the shell opening 26 and/or can be taken from the cardboard-plastic composite shell 10 through the shell opening 26. The storage region 40/the shell opening 26 can be sealed/closed all around (hermetically) by the cover foil.

The storage region 40 of the box 30 is completely lined with the plastic foil 12. The storage region 40 of the box 30 is lined with the plastic foil 12 in such a way that the plastic foil is connected face-to-face with the cardboard of the cardboard blank 16 folded to form the box 30. The plastic foil 12 and the cardboard of the cardboard blank 16 are connected with each other such that simple manual separation of plastic foil 12 and cardboard is enabled for a transfer of the plastic foil 12 and the cardboard to different recycling streams. The cardboard-plastic composite shell 10 has a gripping tab 48. The gripping tab 48 is realized integrally with the plastic foil 12. The gripping tab 48 implements a handling point of the plastic foil 12 for pulling the plastic foil 12 off the cardboard of the cardboard blank 16.

The box 30 folded from the cardboard blank 16 is free of gaps in corner regions 42 of the box 30. The box 30 folded from the cardboard blank 16 is free of gaps, except for the shell opening 26 of the cardboard-plastic composite shell 10.

The cardboard blank 16 that has been folded to form the box 30 is free of intersections and/or overlaps with itself. The cardboard blank 16 that has been folded to form the box 30 is free of intersections and/or overlaps with parts of further cardboard blanks 16. The cardboard blank 16 that has been folded to form the box 30 comprises a sealing edge 28. The sealing edge 28 is configured for a fastening of the cover foil. The sealing edge 28 is realized so as to run completely around an opening of the box 30/around the shell opening 26. The sealing edge 28, like the inner side 44 of the box 30, is completely covered by the plastic foil 12. The cardboard blank 16 that has been folded to form the box 30 has an outer side 46. The outer side 46 of the cardboard blank 16 folded to form the box 30 is situated opposite the inner side 44. The outer side 46 of the cardboard blank 16 folded to form the box 30 is situated opposite the storage region 40. The outer side 46 is free of a covering by the plastic foil 12 or by a further plastic foil 12. A dimensional stability of the cardboard-plastic composite shell 10 is created at least mostly by the plastic foil 12 that is connected with the cardboard blank 16 by lamination. The cardboard of the cardboard blank 16 serves mostly for a reinforcement of an impact protection/a mechanical protection of the cardboard-plastic composite shell 10 and/or for a reduction of a requirement for synthetic material of the cardboard-plastic composite shell 10.

FIG. 2 shows the cardboard blank 16 in a non-folded state. The cardboard blank 16 has a subregion 50 which is configured to form a bottom 18 of the box 30/the cardboard-plastic composite shell 10. The cardboard blank 16 has further subregions 52 which are configured to form sidewalls 20 of the box 30/the cardboard-plastic composite shell 10. When the box 30 is folded from the cardboard blank 16, the further subregions 52 are folded (upwards) out of the plane of the subregion 50. The sidewalls 20 of the box 30/the cardboard-plastic composite shell 10 are situated obliquely or perpendicularly to the bottom 18 of the box 30. An angle 64 included by a sidewall 20 of the box 30 and the bottom 18 of the box 30 is less than 150°, preferably less than 120°. The subregions 52, which are configured to form the sidewalls 20 of the box 30/the cardboard-plastic composite shell 10, have side edges 54, 56. The side edges 54, 56 of the subregions 52 that form the sidewalls 20 are free of gluing tabs. Opposite-situated side edges 54, 56 of the subregions 52 that form the sidewalls 20 contact each other in a state when the cardboard blank 16 has been folded to form the box 30. The opposite-situated side edges 54, 56 of the subregions 52 that form the sidewalls 20 contact each other, in the state when the cardboard blank 16 has been folded to form the box 30, without overlapping each other. The cardboard blank 16 comprises additional further subregions 58, which are configured to form the sealing edge 28 of the box 30/the cardboard-plastic composite shell 10. The subregions 58, which are configured to form portions of the sealing edge 28 of the box 30/the cardboard-plastic composite shell 10, have side edges 60, 62. The side edges 60, 62 of the subregions 58 that form the sealing edge 28 are free of gluing tabs. Opposite-situated side edges 60, 62 of the subregions 58 that form the sealing edge 28 contact each other in a state when the cardboard blank 16 has been folded to form the box 30. The opposite-situated side edges 60, 62 of the subregions 58 that form the sealing edge 28 contact each other, in the state when the cardboard blank 16 has been folded to form the box 30, without overlapping each other. When the cardboard blank 16 is folded to form the box 30, the subregions 58 that form the sealing edge 28 are folded away from the sidewalls 20. In the state when the cardboard blank 16 has been folded to form the box 30, the subregions 58 that form the sealing edge 28 are situated in a common plane. The plane, in which the subregions 58 of the cardboard blank 16 folded to form the box 30, which form the sealing edge 28, are situated, extends parallel to the subregion 50 of the cardboard blank 16 which forms the bottom 18 of the box 30.

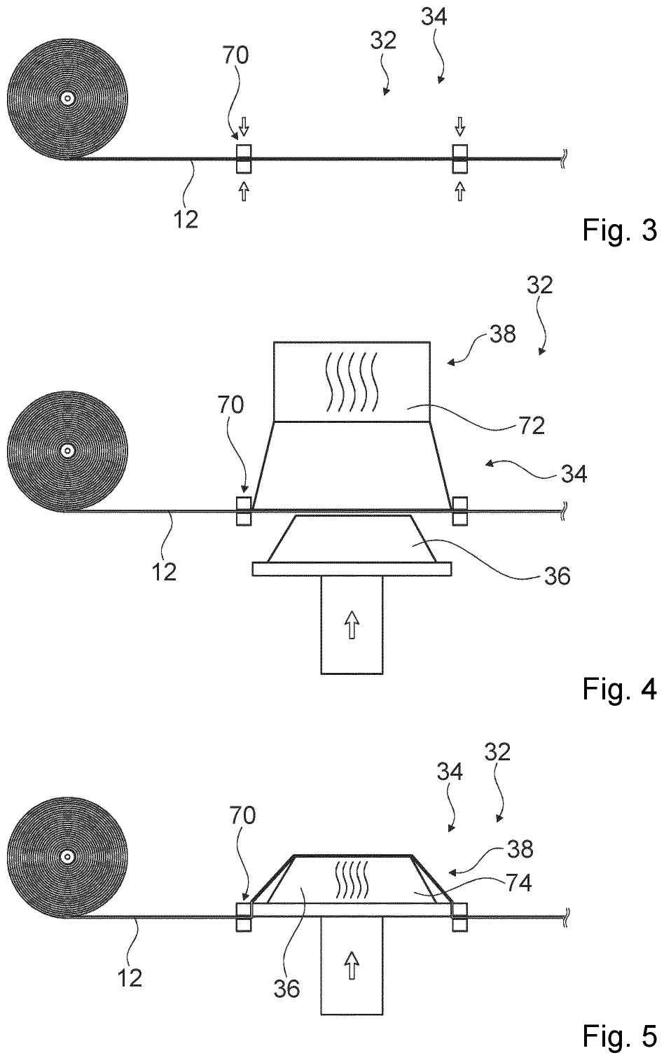

FIGS. 3 to 8 show schematically and step-wise a method for producing the cardboard-plastic composite shell 10 using a production device 32. The production device 32 is configured for carrying out the method according to the invention. For a production of the cardboard-plastic composite shells 10 from respectively one plastic foil 12 and respectively one cardboard blank 16, a method is carried out by the production device 32, which comprises at least one pre-forming step 66 in which the plastic foil 12 is pre-formed, and at least one connecting step 68 in which, following the pre-forming step 66, the plastic foil 12 is connected to the cardboard blank 16. FIG. 1 shows the cardboard-plastic composite shell 10 fully manufactured by means of the production device 32. The production device 32 comprises a foil pre-forming unit 34 (see especially FIGS. 4 and 5). The foil pre-forming unit 34 is configured to pre-form a foil web, firstly provided in planar fashion (see FIG. 3), such that a pre-form of the plastic foil 12 is obtained which corresponds approximately to an inner contour of the finished cardboard-plastic composite shell 10 that is to be achieved. For this purpose, the foil pre-forming unit 34 comprises a stamping tool 36. The stamping tool 36 is realized as a lower punch. The stamping tool 36 has an outer contour corresponding at least substantially to an inner contour of the finished cardboard-plastic composite shell 10 that is to be achieved. The foil pre-forming unit 34 comprises a frame 70, in particular a stamping frame. The frame 70 is configured for clamping a portion of the foil web of the plastic foil 12 in a fixed planar manner before an implementation of the pre-forming step 66. The stamping tool 36 is configured to create, by pressing the plastic foil 12 clamped in the frame 70, a pre-form which roughly corresponds to the inner contour of the finished cardboard-plastic composite shell 10 that is to be achieved.

The foil pre-forming unit 34 comprises at least one heating device 38. The heating device 38 is configured for a heating of the plastic foil 12 before the pre-forming of the plastic foil 12 (see FIG. 4) and/or during the pre-forming of the plastic foil 12 (see FIG. 5). The heating device 38 comprises a first heating unit 72 (see FIG. 4). The first heating unit 72 is embodied as a heating unit 72 that is realized separately from the stamping tool 36. The first heating unit 72 is at least configured for heating the plastic foil 12 before the pre-forming. Alternatively or additionally, the first heating unit 72 may be configured for heating the plastic foil 12 during the pre-forming. The first heating unit 72 comprises a heating fan or a heating radiator. The first heating unit 72 is configured to apply a heated airflow or a heat radiation onto the foil. Alternatively or additionally, the first heating unit 72 may also be configured for heating the stamping tool 36, in particular a surface of the stamping tool 36. The heating device 38 comprises a second heating unit 74 (see FIG. 5). The second heating unit 74 is realized at least partially integrally with the stamping tool 36. The stamping tool 36 comprises an internal heating source, for example a heating coil. The second heating unit 74 is at least configured for heating the plastic foil 12 during the pre-forming. The second heating unit 74 is configured for heating the stamping tool 36, in particular a surface of the stamping tool 36. It is conceivable that the heating device 38 comprises only the first heating unit 72 or only the second heating unit 74. In FIGS. 5 to 8 the further production steps are shown, by way of example, using only the second heating unit 74. Alternatively or additionally, the first heating unit 72 could also be used in the production steps of FIGS. 5 to 8.

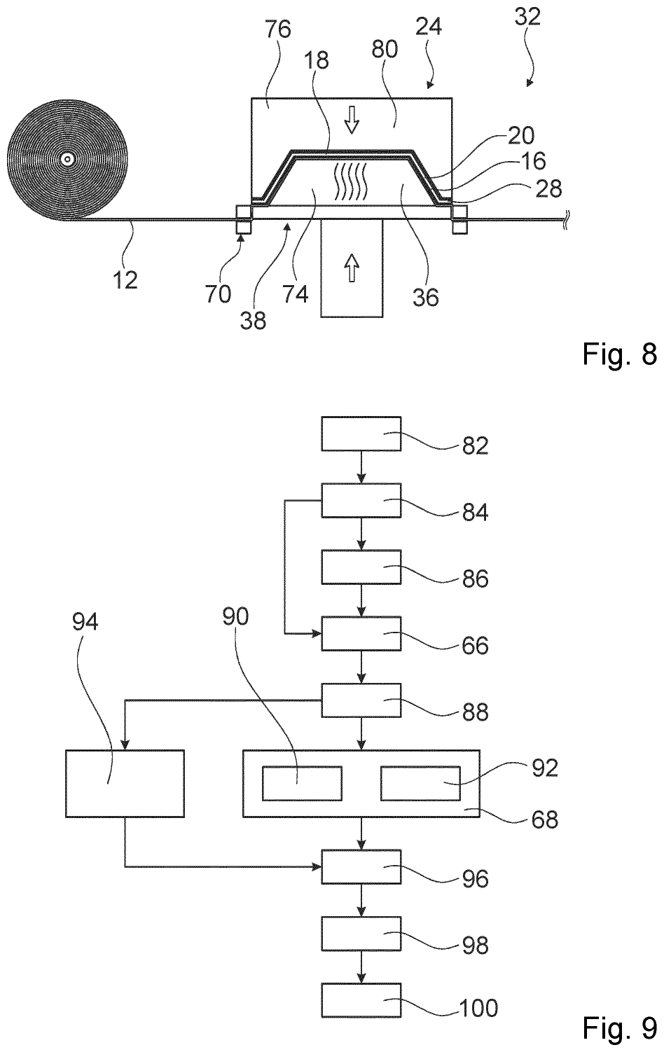

The production device 32 comprises a pressing device 76 (see FIGS. 7a to 8). The pressing device 76 is configured for pressing the cardboard blank 16 onto the pre-formed plastic foil 12. The stamping tool 36 forms a counterpiece as a counterholder against a pressing force of the pressing device 76. The pressing device 76 is first pressed onto the stamping tool 36 from a direction that is opposed to a stamping movement of the stamping tool 46, with the plastic foil 12 and the still non-folded or only partially folded cardboard blank 16 being arranged between the stamping tool 36 and the pressing device 76. By the cardboard blank 16 being pressed onto the plastic foil 12 and, if applicable, simultaneous heating of the plastic foil 12, the plastic foil 12 is laminated onto the cardboard blank 16. During the pressing process of the pressing device 76 the stamping tool 36 remains immobile. In the exemplary embodiment of FIGS. 7a and 7b, at first the bottom 18 of the cardboard blank 16 is laminated and then the sidewalls 20. In the alternative exemplary embodiment of FIG. 8, the bottom 18 and the sidewalls 20 of the cardboard blank 16 are laminated at the same time.

The production device 32 illustrated in FIGS. 7a and 7b comprises a pressing device 76 with a folding mechanism 22. The folding mechanism 22 is configured for folding the cardboard blank 16. The folding mechanism 22 is configured for folding the cardboard blank 16 for a formation and lamination of the sidewalls 20. The folding mechanism 22 presses the subregions 52 of the cardboard blank 16, which form the sidewalls 20, onto the pre-formed plastic foil 12. In addition, it is conceivable that the stamping tool 36 comprises a suction mechanism 78 which is configured to suction the plastic foil 12 to the stamping tool 36, at least in the regions of sidewalls 20 that are to be formed. This advantageously allows optimizing a lamination of the sidewalls 20, in particular as it is possible to prevent a formation of air bubbles or the like between the plastic foil 12 and the stamping tool 36.

The production device 32 illustrated in FIG. 8 comprises a pressing device 76 with a stamp mechanism 24 (instead of the folding mechanism 22 of FIGS. 7a and 7b). The stamp mechanism 24 comprises a further stamping tool 80, which is realized complementarily to the stamping tool 36. The further stamping tool 80 is embodied as an upper punch. The further stamping tool 80 is pressed onto the cardboard blank 16 that has been laid upon the pre-formed plastic foil 12 from a direction that is opposed to a direction in which the stamping tool 36 is moved during the pre-forming of the plastic foil 12. The further stamping tool 80 folds and laminates in one common work step.

FIG. 9 shows a schematic flowchart of a method for producing the cardboard-plastic composite shell 10. FIG. 1 shows the cardboard-plastic composite shell 10 that has been fully manufactured by the method described. In at least one method step 82, a foil web of the plastic foil 12 is spread, e. g. rolled out, in a planar fashion. In the method step 82 the plastic foil 12 is provided. In at least one further method step 84, a section of the foil web of the plastic foil 12 is clamped into the frame 70 (see also FIG. 3). In at least one (optional) further method step 86, at least the section of the plastic foil 12 that is clamped in the frame 70 is heated, for example by means of the first heating unit 72. In the method step 86 the plastic foil 12 is heated directly before the pre-forming. In the pre-forming step 66 the stamping tool 36 is pressed into the frame 70 (see also FIGS. 4 and 5). Herein the plastic foil 12 is pre-formed. The stamping tool 36 may herein be heated, for example by the second heating unit 74. In the pre-forming step 66 the plastic foil 12 is heated during the pre-forming. It is however also conceivable, depending on the chemical-physical properties of the plastic foil 12, that the heating may be completely dispensed with during the pre-forming. In the pre-forming step 66 the plastic foil 12 is pre-formed into the shell shape 14, which preferably already has a strong similarity to the shape of the inner side 44 of the cardboard-plastic composite shell 10. Optionally the plastic foil 12 is already in the pre-forming step 66 suctioned sideways to the stamping tool 36 (see also FIG. 7a). In the pre-forming step 66 the plastic foil 12 is pre-formed in order to form the shell shape 14.

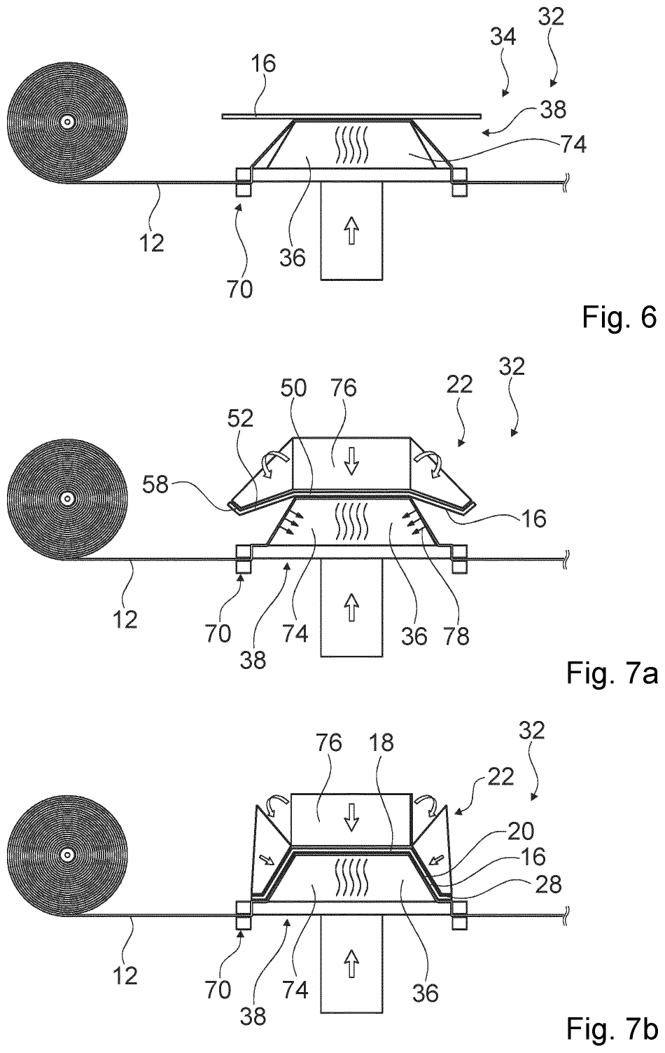

In a further method step 88, the cardboard blank 16 is laid upon the pre-formed plastic foil 12. In the method step 88 the cardboard blank 16 is provided. The cardboard blank 16 provided in the method step 88 is non-folded or incompletely folded directly before being connected to the pre-formed plastic foil 12. The cardboard blank 16 is herein laid onto the plastic foil 12 on a side of the plastic foil 12 that is situated opposite the stamping tool 36 (see also FIG. 6). In the following connecting step 68, the plastic foil 12 is laminated to the cardboard blank 16. In the connecting step 68, the cardboard blank 16 is connected to the already pre-formed plastic foil 12 in order to form the cardboard-plastic composite shell 10. In the connecting step 68, the cardboard blank 16 is connected to the plastic foil 12 in such a way that the plastic foil 12 and the cardboard blank 16 can be separated manually. In the connecting step 68, the cardboard blank 16 is connected to the plastic foil 12 in such a way that the plastic foil 12 and the cardboard blank 16 can be separated in a manner suitable for recycling. The connection of the cardboard blank 16 to the plastic foil 12, in particular the connecting step 68, is realized completely without gluing materials, i. e. in particular completely free of an application of an additional gluing material.

If the connecting step 68 is carried out with the folding mechanism 22 shown in FIGS. 7a and 7b, when connecting the cardboard blank 16 to the pre-formed plastic foil 12, the subregion 50 of the cardboard blank 16, which is intended to form the bottom 18 of the cardboard-plastic composite shell 10, is realized in a first partial connecting step 90 which lies temporally before a second partial connecting step 92, in which the further subregions 52 of the cardboard blank 16, intended to form the sidewalls 20 of the cardboard-plastic composite shell 10, are connected to the plastic foil 12. In the connecting step 68, in this case the cardboard blank 16 is folded onto the plastic foil 12 by means of the folding mechanism 22. Herein the cardboard blank 16 is folded in such a way that the folded cardboard blank 16 remains free of intersections and/or overlaps with itself and with further cardboard blanks. Furthermore, in the connecting step 68, in particular in the second partial connecting step 92, the cardboard blank 16 is folded so as to create the planar and layer-jump-free sealing edge 28 which runs around the shell opening 26 of the finished cardboard-plastic composite shell 10. In the folding of the cardboard blank 16 in the connecting step 68, the box 30 is created from the cardboard blank 16. The production of the box 30 from the cardboard blank 16 is realized completely without gluing materials. The production of the box 30 from the cardboard blank 16 is realized completely without using/applying additional gluing materials.

As an alternative, an alternative connecting step 94, requiring no folding mechanism 22, may be carried out instead of the connecting step 68 in which the folding mechanism 22 is used. In the alternative connecting step 94, when the cardboard blank 16 is connected to the pre-formed plastic foil 12, the cardboard blank 16 is folded onto the plastic foil 12/folded to form the box 30 by means of the stamp mechanism 24, and is at the same time connected to the plastic foil 12 in the same work step (see also FIG. 8). In the alternative connecting step 94 the plastic foils 12 and the cardboard blanks 16, which are arranged layer-wise above one another, are pressed with each other between two complementary stamping tools 36, 80, wherein the plastic foil 12 was already pre-formed temporally before the pressing with the cardboard blank 16, and preferably the stamping tool 36 that adjoins the plastic foil 12 is heated.

In at least one further method step 96, the fully formed cardboard-plastic composite shell 10 is taken from the production device 32. The non-closed cardboard-plastic composite shell 10 is stackable with further non-closed cardboard-plastic composite shells 10. In at least one further method step 98, the fully formed cardboard-plastic composite shells 10 are fed to a filling line, where the storage region 40 of the cardboard-plastic composite shells 10 is filled with objects. In at least one further method step 100, the filled cardboard-plastic composite shells 10 are fed to a closing line, where the storage region 40 of the filled cardboard-plastic composite shells 10 is closed, in particular gas-tightly closed, by the cover foil. Before a closing of the filled cardboard-plastic composite shells 10, the air remaining in the cardboard-plastic composite shells 10 may be replaced by a gas, in particular an inert gas/shielding gas like nitrogen or the like.

Please amend the listing of claims as follows:

1. A method for producing a cardboard-plastic composite shell (10), comprising at least the method steps (66, 68, 82, 88):
providing a plastic foil (12),
pre-forming the plastic foil (12) to form a shell shape (14),
providing a cardboard blank (16),
connecting the cardboard blank (16) to the already pre-formed plastic foil (12) in order to form the cardboard-plastic composite shell (10),
wherein the cardboard blank (16) provided is not folded or incompletely folded directly before the connection to the pre-formed plastic foil (12), wherein when the cardboard blank (16) is connected to the pre-formed plastic foil (16), the cardboard blank (16) is folded onto the plastic foil (12) by a stamp mechanism (24).

2. The method according to claim 1, wherein the cardboard blank (16) is connected to the plastic foil (12) in such a way that the plastic foil (12) and the cardboard blank (16) are separable manually.

3. The method according to claim 1, wherein the plastic foil (12) is connected to the cardboard blank (16) by lamination.

4. The method according to claim 3, wherein a dimensional stability of the cardboard-plastic composite shell (10) is created by the plastic foil (12) that is connected with the cardboard blank (16) by lamination.

5. The method according to claim 1, wherein in the pre-forming the plastic foil (12) is brought, in particular drawn, into a shape which at least substantially corresponds to an inner shape of the cardboard-plastic composite shell (10) that is to be attained.

6. The method according to claim 1, wherein the plastic foil (12) is heated during the pre-forming or directly before the pre-forming.

7. The method according to claim 1, wherein when the cardboard blank (16) is connected to the pre-formed plastic foil (12), a subregion (50) of the cardboard blank (16), which is configured to form a bottom (18) of the cardboard-plastic composite shell (10), is connected to the plastic foil (12) before a further subregion (52) of the cardboard blank (16) which is configured to form a sidewall (20) of the cardboard-plastic composite shell (10).

8. (canceled)

9. The method according to claim 1, wherein the cardboard blank (16) is folded in such a way that the folded cardboard blank (16) remains free of intersections and/or overlaps with itself and with further cardboard blanks.

10. The method according to claim 1, wherein when the cardboard blank (16) is folded, a sealing edge (28) is created which is planar and/or free of layer jumps, and which in particular runs around a shell opening (26) of the finished cardboard-plastic composite shell (10).

11. The method according to claim 1, wherein at least the connection of the cardboard blank (16) to the plastic foil (12) and/or at least a production of a box (30) from the cardboard blank (16) are/is realized completely free of an application of additional gluing materials.

12. A production device (32) for a production of cardboard-plastic composite shells (10) at least from respectively one plastic foil (12) and respectively one cardboard blank (16) by a method according to claim 1, comprising a pre-forming of the plastic foil (12) and a following connecting of the plastic foil (12) to the cardboard blank (16), the production device (32) comprising a foil pre-forming unit (34) and a pressing device (76) with a stamp mechanism (24), wherein the foil-preforming unit (34) comprises at least one stamping tool (36) having an outer contour which corresponds at least substantially to an inner contour of the finished cardboard-plastic composite shell (10) that is to be attained, wherein the stamp mechanism (24) comprises a further stamping tool (80), which is realized complementarily to the stamping tool (36) and is configured for folding and laminating in one common work step.

13. The production device (32) according to claim 12, wherein the foil pre-forming unit (34) comprises at least one heating device (28) for a heating of the plastic foil (12) before and/or during a pre-forming of the plastic foil (12).

14. The production device (32) according to claim 13, wherein the heating device (28) is realized at least partially integrally with the stamping tool (36).

15. The method according to claim 1, wherein in the pre-forming the plastic foil (12) is drawn into a shape which at least substantially corresponds to an inner shape of the cardboard-plastic composite shell (10) that is to be attained.

16. The method according to claim 10, wherein the sealing edge (28) runs around a shell opening (26) of the finished cardboard-plastic composite shell (10).
